(19) United States
(12) Patent Application Publication
(10) Pub. No.: US 2014/0349650 A1
(43) Pub. Date: Nov. 27, 2014

(54) Temporarily Serving a User Equipment by a Second Cell

(71) Applicants: Johanna Katariina Pekonen, Espoo (FI); Antti Anton Toskala, Espoo (FI)

(72) Inventors: Johanna Katariina Pekonen, Espoo (FI); Antti Anton Toskala, Espoo (FI)

(21) Appl. No.: 14/375,498

(22) PCT Filed: Jan. 30, 2012
(86) PCT No.: PCT/EP2012/051439

§ 371 Date: Jul. 30, 2014

(51) Int. Cl. H04W 36/08

(52) U.S. Cl. CPC H04W 36/08
USPC 455/436

(57) ABSTRACT

A method includes receiving, by a first base station, a request for a service from the user equipment, determining a needed capacity for the requested service, and determining a need to use capacity being provided by a second base station based on the needed capacity for the requested service. The method includes handing over the user equipment from the first base station of the first cell to the second base station of the second cell. The method also includes handing over the user equipment back from the second base station of the second cell to the first base station of the first cell in response to an end of the need to use capacity being provided by the second base station.

### FIELD OF INVENTION

The present invention relates to the field of cellular networks and in particular to cellular networks comprising different types of cells, in particular of different operators.

### ART BACKGROUND

In cellular network systems, cells of different types are operating partially in the same environment. Due to high load conditions within one cell, it may be desired to offload some data traffic to other cells.

In current 3GPP, network operators may pre-configure selection rules for user equipments (UEs) and when users uses applications, like browsers, the UE may use these rules to select between different networks (TS 23.402 Chapter 4.8.2.1) using ANDSF. ANDSF is used to assist UEs to discover non-3GPP access networks, e.g. Wi-Fi or WIMAX, that can be used for data communications in addition to 3GPP access networks.

There may be a need for an improved and flexible system and method being adapted to allow borrowing capacity from another cell or operator without the need for full network sharing.

### SUMMARY OF THE INVENTION

This need may be met by the subject matter according to the independent claims. Advantageous embodiments of the present invention are described by the dependent claims.

According to a first aspect of the invention there is provided a method for temporarily serving a user equipment by a second cell within a cellular network system, wherein the user equipment is initially served by a first cell, the first cell being assigned to a first base station, wherein the cellular network system comprises the first cell and the second cell being assigned to a second base station. The method comprises receiving, by the first base station, a request for a service from the user equipment, determining a needed capacity for the requested service, determining a need to use capacity being provided by the second base station based on the needed capacity for the requested service, handing over the user equipment from the first base station of the first cell to the second base station of the second cell, and handing over the user equipment back from the second base station of the second cell to the first base station of the first cell in response to an end of the need to use capacity being provided by the second base station.

This aspect of the invention is based on the idea to improve the flexibility of off-loading data traffic to another cell. The flexibility may be achieved by taking into account actual requested services and the associated needed capacity.

For instance, if a user equipment (UE) requests a specific service, for example video telephony, the serving base station a capacity which would be needed for this service. “Capacity” in this context may refer to a bandwidth or data rate which would be necessary to be provided by the first base station. In case that the actual load conditions within the first (serving) cell are not sufficient to fulfill the necessary capacity need (for instance based on a high load within the serving cell), the base station may decide to off-load the requested service to another cell. Thus, the UE may be handed over and temporarily served by another cell. As soon as need for transfer some capacity need to another cell, for instance when the requested service is terminated, the UE will be handed over back to the serving cell.

The idea of this method is to use a temporary resource sharing without the need of a complete network sharing. For this, dynamic rules, based on a needed capacity, are used for sharing the resources. The described method refers to off-loading of data traffic (via a UE handover) from a first (for instance macro) cell to a second (for instance micro) cell, when, due to traffic requirements, it seems to be not possible to provide a requested service. Once the service has been provided, the UE is handed back to its original cell. So in effect, this is a temporary handover of a UE.

Currently 3GPP works in a way where network operators pre-configure selection rules to UEs and when users uses applications, like browsers, the UE uses these rules to select between different networks (TS 23.402 Chapter 4.8.2.1) using ANDSF. ANDSF may assist UEs to discover non-3GPP access networks, (e.g. Wi-Fi or WIMAX) that can be used for data communications in addition to 3GPP access networks. Based on the described method, more dynamic rules can be used based on checking the QoS requirements of a requested service.

The term “base station” in this context may denote any kind of physical entity being able to hold one or more cells. A base station in this context may be any kind of network device providing the required functionality for the method, it may also be a transceiver node in communication with a centralized entity. The base station may be for example a NodeB or eNB.

The first base station and the second base station may be of the same kind of base station or may be different base stations.

The term “handover” may refer to a procedure for a handover as it is known in the art.

According to an embodiment of the invention, determining a needed capacity for the requested service comprises estimating, by the first base station, quality of service requirements for the requested service.

According to this embodiment, the needed capacity may be determined by estimating quality of service requirements being associated with the requested service.

For instance, if a user equipment (UE) requests a specific service, for example video telephony, the serving base station estimates the necessary quality of service requirements for this service. In case that the actual load conditions within the first (serving) cell are not sufficient to fulfill the necessary quality of service requirements, the base station may decide to off-load the requested service to another cell. Thus, this embodiment may be implemented in using quality of service (QoS) requirements of requested services from the UE. When a high QoS is required, the UE can be handed over to the second cell. Once the service has been provided, the UE is handed back to its original cell.

According to a further embodiment of the invention, the method further comprises, after determining a need to use capacity being provided by the second base station based on the needed capacity for the requested service, scheduling, by the first base station, a handover based on the needed capacity.

Scheduling a handover in this context may refer to the preparation to hand over the UE from the first to the second base station.

According to a further embodiment of the invention, the first cell provides a larger coverage than the second cell.

The first cell may be for instance a macro cell. The second cell may be a micro cell, pico cell or femto cell or any other kind of cell being smaller as the first cell.

In one embodiment, the second cell may be micro cell using a 3.5 GHz spectrum.

The first cell may be a cell relating to an LTE cell. The second cell may be a cell relating to LTE, W-Fi or WiMAX. WiFi or Wi-Fi in the context of this invention may refer to a wireless local area network (WLAN).

According to a further embodiment of the invention, the first base station corresponds to a first type of base station and the second base station corresponds to a second type of base station.

The first base station may be for instance a base station or access node as used in LTE or 3GPP. The second base station may be for instance a base station or access node as used for any kind of wireless network (Wi-Fi or WiMAX).

According to a further embodiment of the invention, the first base station is operated by a first operator and the second base station is operated by a second operator.

The first base station and the second base station may be operated by different operators. In one embodiment, the operators may exchange further information via the base stations in view of the needed resources of the second base station and second cell. These information may be used for instance for billing purposes for example to calculate the capacity used from the second cell and possible payments due to cover for the capacity used in the second cell if that is owned by another operator.

According to a further embodiment of the invention, scheduling a handover comprises performing radio resource measurements for detecting the second cell.

Radio resource measurements (RRM) refer to measurements which may be used to detect neighboring cells or networks. After detecting neighboring cells, the first base station may determine or select a cell being the most appropriate as the second cell.

According to a further embodiment of the invention, scheduling a handover comprises exchanging information between the first base station and the second base station for preparing the handover.

For instance, information in view of the requested service and the needed quality of service requirements may be exchanged. Further, information in view of the UE to be used for the handover or any other kind of information may be exchanged.

According to a further embodiment of the invention, exchanging information comprises exchanging information via a direct communication and/or via an indirect communication.

For instance, a X2 interface and X2 signalling may be used for a direct communication between the base stations to exchange information. The base stations may also communicate via a higher level unit, like a central control unit or core unit (for example a EPC, evolved packet core). This may be done in addition or alternatively.

According to a further embodiment of the invention, the method further comprises handing over the user equipment back from the second base station of the second cell to the first base station of the first cell in response to a trigger event.

In addition to the back handover in response to the end of the requested service, the UE may also be handed over back to the first base station due to any kind of trigger event.

According to a further embodiment of the invention, the trigger event corresponds to a detection that the quality of the connection via the second base station of the second cell decreases.

A decrease of the quality may be determined based on a threshold of the signal conditions. If the signal condition or signal quality falls below a predefined threshold value, the back handover may be triggered. Furthermore or in addition, a decreasing rate of the signal quality may be determined. If the rate is below a predefined rate, the handover may be triggered.

Signal quality in this context may refer to conditions of the communication channel between the UE and the second base station within the second cell.

According to a further embodiment of the invention, the first base station monitors the quality of the connection of the user equipment to the second base station of the second cell based on information received from the second base station.

The second base station may report to the first base station the current channel conditions or signal quality between the UE and the second base station, the reported quality metrics may include for example Channel Quality Information (CQI), Channel State Information (CSI) or measurements done in the base station based on the received Sounding Reference Signal (SRS) transmission by the terminal in the uplink direction. Based on this information, the first base station may decide whether to trigger a back handover of the UE or not.

According to a further embodiment of the invention, the quality of service requirements comprises at least one of data rate, channel quality, and delay.

Also any other kind of QoS requirements may be appropriate and may be considered when selecting a second cell and scheduling a temporary handover or temporary serving of the UE by the second cell.

According to a second aspect of the invention, there is provided a first base station for temporarily serving a user equipment by a second cell within a cellular network system, wherein the user equipment is initially served by a first cell, the first cell being assigned to the first base station, wherein the cellular network system comprises the first cell and the second cell being assigned to a second base station. The first base station comprises a receiving unit being adapted to receive a request for a service from the user equipment, a determination unit being adapted to determine a needed capacity for the requested service and being adapted to determine a need to use capacity being provided by the second base station based on the needed capacity for the requested service, and a control unit being adapted to hand over the user equipment from the first base station of the first cell to the second base station of the second cell, and being adapted to hand over the user equipment back from the second base station of the second cell to the first base station of the first cell in response to an end of the need to use capacity being provided by the second base station.

The first and the second base station may be any type of access point or point of attachment, which is capable of providing a wireless access to a cellular network system. Thereby, the wireless access may be provided for a user equipment or for any other network element, which is capable of communicating in a wireless manner. The first and the second base station may be a NodeB, eNB, home NodeB or HeNB, or any other kind of access point. The first base station may in particular be used for an LTE or 3GPP cell and communication. The second base station may in particular be used for a smaller cell, for instance in respect to Wi-Fi or WiMAX.

The first base station may comprise a receiving unit, for example a receiver as known by a skilled person. The first base station may also comprise a transmitting or sending unit, for example a transmitter. The receiver and the transmitter may be implemented as one single unit, for example as a transceiver. The transceiver or the receiving unit and the sending unit may be adapted to communicate with the user equipment and/or the second base station via an antenna.

The second base station may comprise a receiving unit, for example a receiver as known by a skilled person. The second base station may also comprise a transmitting or sending unit, for example a transmitter. The receiver and the transmitter may be implemented as one single unit, for example as a transceiver. The transceiver or the receiving unit and the sending unit may be adapted to communicate with the user equipment via an antenna.

The first and the second base stations may exchange information via a direct communication and/or via an indirect communication. For instance, a X2 interface and X2 signalling may be used for a direct communication between the base stations to exchange information.

The first base station further comprises a determination unit and a control unit. The determination unit and the control unit may be implemented as single units or may be implemented for example as part of a standard control unit, like a CPU or a microcontroller.

The second base station may also comprise a control unit being adapted to control the handover procedures of the user equipment. The control unit may be implemented as a single unit or may be implemented for example as part of a standard control unit, like a CPU or a microcontroller.

The user equipment (UE) may be any type of communication end device, which is capable of connecting with the described base stations. The UE may be in particular a cellular mobile phone, a Personal Digital Assistant (PDA), a notebook computer, a printer and/or any other movable communication device.

The user equipment may comprise a receiving unit or receiver which is adapted for receiving signals from the first and the second base station. The user equipment may comprise a transmitting unit for transmitting signals. The transmitting unit may be a transmitter as known by a skilled person. The receiver and the transmitting unit may be implemented as one single unit, for example as a transceiver. The transceiver or the receiver and the transmitting unit may be adapted to communicate with the first and the second base station via an antenna.

According to a third aspect of the invention, there is provided a cellular network system. The cellular network system comprises a first base station as described above.

Generally herein, the method and embodiments of the method according to the first aspect may include performing one or more functions described with regard to the second or third aspect or an embodiment thereof. Vice versa, the base station or cellular network system and embodiments thereof according to the second and third aspect may include units or devices for performing one or more functions described with regard to the first aspect or an embodiment thereof.

According to a fourth aspect of the herein disclosed subject-matter, a computer program for temporarily serving a user equipment by a second cell is provided, the computer program being adapted for, when executed by a data processor assembly, controlling the method as set forth in the first aspect or an embodiment thereof.

As used herein, reference to a computer program is intended to be equivalent to a reference to a program element and/or a computer readable medium containing instructions for controlling a computer system to coordinate the performance of the above described method.

The computer program may be implemented as computer readable instruction code by use of any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The herein disclosed subject matter may be realized by means of a computer program respectively software. However, the herein disclosed subject matter may also be realized by means of one or more specific electronic circuits respectively hardware. Furthermore, the herein disclosed subject matter may also be realized in a hybrid form, i.e. in a combination of software modules and hardware modules.

In the above there have been described and in the following there will be described exemplary embodiments of the subject matter disclosed herein with reference to a cellular network system, a base station and a method of temporarily serving a user equipment by a second cell. It has to be pointed out that of course any combination of features relating to different aspects of the herein disclosed subject matter is also possible. In particular, some embodiments have been described with reference to apparatus type embodiments whereas other embodiments have been described with reference to method type embodiments. However, a person skilled in the art will gather from the above and the following description that, unless otherwise notified, in addition to any combination of features belonging to one aspect also any combination between features relating to different aspects or embodiments, for example even between features of the apparatus type embodiments and features of the method type embodiments is considered to be disclosed with this application.

The aspects and embodiments defined above and further aspects and embodiments of the present invention are apparent from the examples to be described hereinafter and are explained with reference to the drawings, but to which the invention is not limited.

### BRIEF DESCRIPTION OF THE DRAWING

FIG. 1 shows a cellular network system according to an exemplary embodiment of the present invention.

FIG. 2 shows a cellular network system according to a further exemplary embodiment of the present invention illustrating a handover procedure.

FIG. 3 shows a cellular network system according to a further exemplary embodiment of the present invention illustrating a back handover procedure.

FIG. 4 shows a base station and a user equipment within a cellular network system according to an exemplary embodiment of the invention.

It is noted that in different figures, similar or identical elements are provided with the same reference signs.

### DETAILED DESCRIPTION

In the following, embodiments of the herein disclosed subject matter are illustrated with reference to the drawings and reference to aspects of current standards, such as LTE. However, such reference to current standards is only exemplary and should not be considered as limiting the scope of the claims.

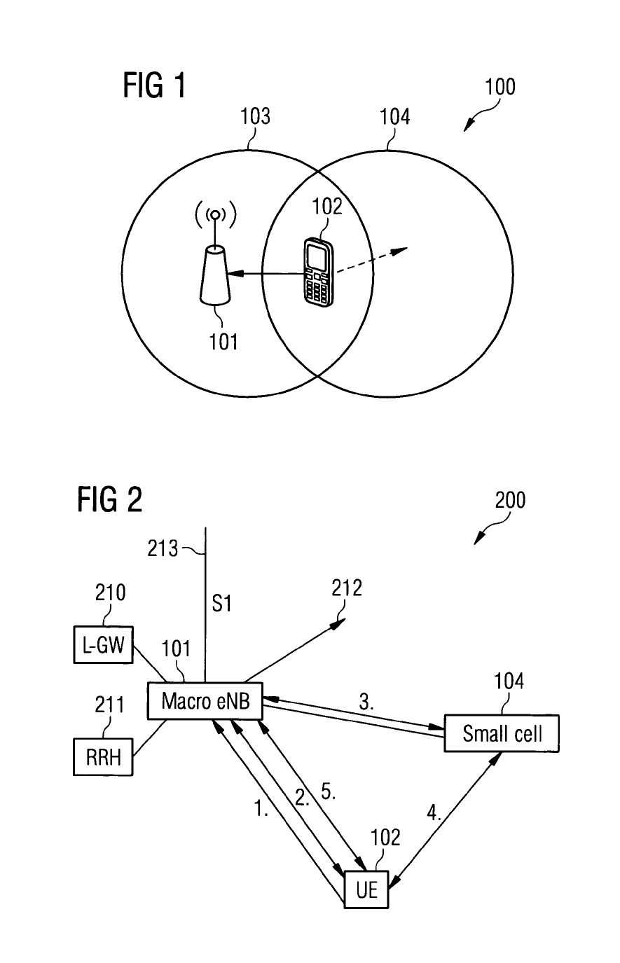

FIG. 1 shows a cellular network system 100. A user equipment 102 is initially served by a first cell 103 of the cellular network system. The first cell is assigned to a first base station 101. The cellular network system comprises further a second cell 104 being assigned to a second base station.

The first base station 101 receives a service request by the user equipment (UE) and determines a needed capacity for the requested service, for instance based on corresponding quality of service (QoS) requirements. Based on this, the first base station determines an actual load of the first cell and estimates whether the first cell can fulfill the requested service with the needed QoS requirements. If not, the first base station 101 hands over the user equipment 102 to the second base station of the second cell 104. In response to an end of the need to use capacity provided by the second base station, for instance when the requested service is terminated, the UE 102 is handed over back from the second base station of the second cell 104 to the first base station 101 of the first cell 103.

The first cell is in particular a macro cell, for instance corresponding to a wide area network like LTE (Long Term Evolution). The second cell is in particular a smaller cell, for instance a micro cell.

Off-loading data due to the increase in traffic volumes is getting more and more important. Earlier offloading to WiFi has been mentioned as one possibility but it has limitations due for example limited power levels and uncertainty of the availability of the capacity (as the spectrum is publically available). This earlier offloading has been based on a decision of the UE which network should be used.

In 3GPP the specifications contain support for 3.5 GHz spectrum, and this spectrum is well suited for the local off-loading (both outdoor and indoor) scenarios as in several cases spectrum owners have a large part of the spectrum and there is more than 100 MHz in total available. The 3.5 GHz spectrum however is generally not held by the wide area operators, but rather by smaller operators.

Small spectrum owners do not necessary wish to invest in the full blown LTE network, especially if their main business is using the spectrum for other purposes such as fixed ADSL (with for example fixed WiMax) operating in the 3.5 GHz spectrum currently. So traditional network sharing may be complicated, while the operators owning the spectrum still are expected also to own the BTS (base stations) equipments and sites (and in many cases have already sites used for WiMax) to enable serving own customers or to allow to sell capacity to more than one other operator.

This issue may be solved by introducing a possibility to connect the cell of a capacity re-seller (owner of a smaller cell in another frequency or frequency band, for example with 3.5 GHz) to a micro/macro cell of a cellular operator (operator of a macro cell) in a such a way that, when a need is identified to ensure better QoS (especially data rate), then the UE may be moved (after measurements which ensure the UE is within the small cell coverage area) to the cell of “capacity re-seller”. The connection of the small cell to the EPC may remain via the cellular operator macro/micro base station. Together with the data flow information of the quality (such as the LTE wideband CQI (Channel Quality Indicator), some average off) may be provided to the cellular operator via a control plane connection between the sites. Once the demand is estimated to be over (download ending, cellular operator has again free capacity, CQI indicates low quality in the capacity re-seller frequency etc. . . . ) the handover may be triggered by the cellular operator by signalling to the cell of the capacity re-seller. This may also happen if the connection would be noticed to be in danger of being lost due poor coverage of the small cell. The eNodeB or base station of the cellular operator may then count the data volume transferred via the small cell (assuming user plane is routed via the eNB of the cellular operator) and the information can be used for charging purposes as part of a leasing contract between the cellular operator and the capacity re-seller. The possible reasons to trigger the need for improved QoS are for example request to access a service, such as buying a movie or game on-line etc, desire to serve users with better QoS profile with higher data rates, own network congestion.

The capacity re-seller might be only focused on re-selling or alternative could re-sell a part of the capacity and use the rest for own customers. Relevant interfaces may be (assuming all the time LTE) more likely the S1 interface or alternatively the X2 interface if a separate S1 connection exists for the own core (latter with continuous data forwarding assumed, then making handover but not updating the core network connection).

In one embodiment, there may be a key provided to the UE from the cellular operator which is then enabling access for certain amount of time.

One example for a handover procedure is shown in FIG. 2. The cellular network system 200 comprises the first base station 101 providing a macro cell and the second cell 104 as a small cell. There are shown some standard connections and units of the first base station: Local Gateway 210 and remote radio head 211. The shown S1 interface connection 213 may be used for communication with a control unit like EPC.

In the following, the exemplary handover procedure will be described (the numbers referring to the numbers in the figure):
1. The UE 102 requests a high data rate service
2. The UE 102 orders some RRM measurements (for instance inter-frequency for 3.5 GHz)
3. The first base station 101 and the second base station of the second cell 104 prepare and perform the handover procedure towards the small cell 104
4. The UE receives the high data rate service via the small cell
5. After the leasing of the small cell capacity is over, for instance the service is terminated, the UE returns to the macro cell coverage

The first base station may send any “counter information” 213 to a common central control unit for being used for charging between the cellular operator and the capacity reseller.

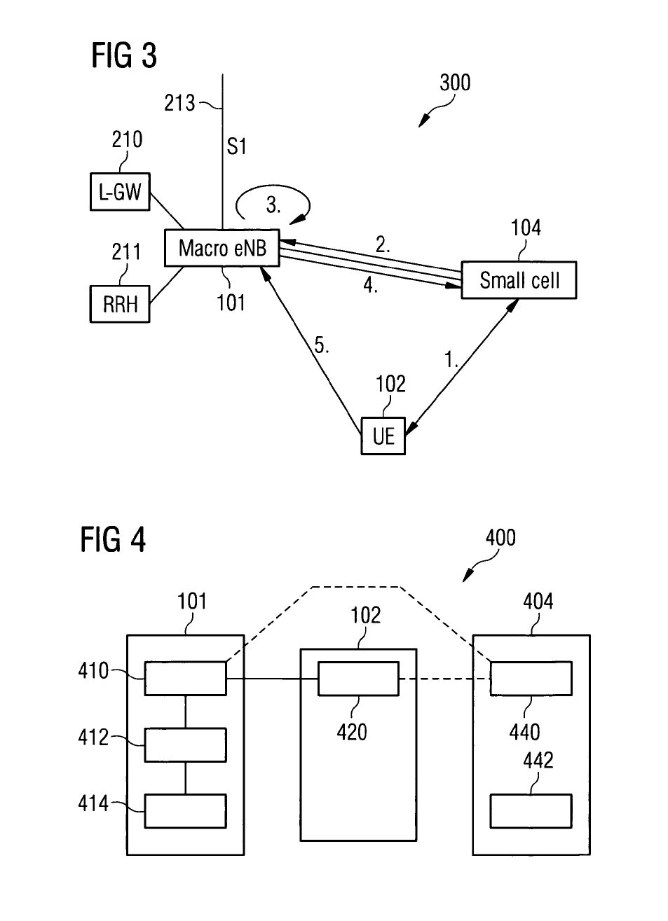

FIG. 3 shows an exemplary back handover and monitoring procedure in a cellular network system 300 (the numbers referring to the numbers in the figure).
1. The UE is connected via the small cell 104
2. The small cell 104 informs the macro base station 101 about the quality of the stream between the small cell and the UE
3. The macro base station 101 monitors the small cell reporting
4. In case the quality is decreasing too much and the capacity in the macro layer would be available, the macro base station 101 requests the small cell 104 to trigger for a handover towards the first cell again
5. The UE is moved back to the control of the macro base station 101

FIG. 4 shows a cellular network system 400 according to an exemplary embodiment of the invention. The cellular network system comprises a first base station 101, a user equipment 102 being initially served by the first base station, and a second base station 404.

The first base station comprises a receiving unit being adapted to receive a request for a service from the user equipment, a determination unit 412 being adapted to determine a needed capacity for the requested service and being adapted to determine need to use capacity being provided by the second base station based on the needed capacity for the requested service, and a control unit 414 being adapted to hand over the user equipment from the first base station of the first cell to the second base station 404 of the second cell, and being adapted to hand over the user equipment back from the second base station 404 of the second cell to the first base station of the first cell in response to an end of the need to use capacity being provided by the second base station.

The first base station may be any type of access point or point of attachment, which is capable of providing a wireless access to a cellular network system. Thereby, the wireless access may be provided for the user equipment, or for any other network element, which is capable of communicating in a wireless manner. The first base station may be a NodeB, eNB, home NodeB or HeNB, or any other kind of access point.

The first base station may comprise a receiving unit, for example a receiver as known by a skilled person. The base station may also comprise a transmitting or sending unit, for example a transmitter. The receiver and the transmitter may be implemented as one single unit, for example as a transceiver 410. The transceiver or the receiving unit and the sending unit may be adapted to communicate with the user equipment and the second base station via an antenna.

The determination unit 412 and the control unit 414 may be implemented as single units or may be implemented for example as part of a standard control unit, like a CPU or a microcontroller.

The second base station may be any type of access point or point of attachment, which is capable of providing a wireless access to a cellular network system. Thereby, the wireless access may be provided for the user equipment, or for any other network element, which is capable of communicating in a wireless manner. The second base station may be a NodeB, eNB, home NodeB or HeNB, or any other kind of access point, in particular used for a micro cell.

The second base station may comprise a receiving unit, for example a receiver as known by a skilled person. The second base station may also comprise a transmitting or sending unit, for example a transmitter. The receiver and the transmitter may be implemented as one single unit, for example as a transceiver 440. The transceiver or the receiving unit and the sending unit may be adapted to communicate with the user equipment via an antenna.

The second base station 404 may also comprise a control unit 442 being adapted to control the handover procedures of the user equipment. The control unit 442 may be implemented as a single units or may be implemented for example as part of a standard control unit, like a CPU or a microcontroller.

The user equipment (UE) may be any type of communication end device, which is capable of connecting with the described base stations. The UE may be in particular a cellular mobile phone, a Personal Digital Assistant (PDA), a notebook computer, a printer and/or any other movable communication device.

The user equipment may comprise a receiving unit or receiver which is adapted for receiving signals from the base station. The user equipment may comprise a transmitting unit for transmitting signals. The transmitting unit may be a transmitter as known by a skilled person. The receiver and the transmitting unit may be implemented as one single unit, for example as a transceiver 420. The transceiver or the receiver and the transmitting unit may be adapted to communicate with the base stations via an antenna.

The described method and system may provide inter alia the following advantages. The spectrum use can be maximised. An operator with a spectrum (such as 3.5 GHz) less suited for full coverage use can leverage the spectrum asset and focus his investment only in the radio. The basic form of the solution might not require anything else from the UE but only support of the extra frequency band (such as 3.5 GHz) in question. The cellular operator may have a possibility to get the UE back at any time if for example the QoS is not sufficient or own network has cleared the capacity bottleneck. The presented solution can be used also with multiple cellular operators. In that case the small cell may broadcast multiple PLMN Ids and may have the connection to eNBs of multiple cellular operators. Compared to the carrier aggregation the solution may still keep the base station sites independent, might not require the common scheduler and may allow only part of the capacity to be leased while does not require either full carrier aggregation capable devices. Simply support for the 3.5 GHz band may be sufficient from UE side to enable the capacity leasing, while carrier aggregation specific band combination with 3.5 GHz band would need to be specified and no such cases are currently planned in 3GPP work for carrier aggregation.

Having regard to the subject matter disclosed herein, it should be mentioned that, although some embodiments refer to a “base station”, “eNB”, etc., it should be understood that each of these references is considered to implicitly disclose a respective reference to the general term “network component” or, in still other embodiments, to the term “network access node”. Also other terms which relate to specific standards or specific communication techniques are considered to implicitly disclose the respective general term with the desired functionality.

It should further be noted that a base station as disclosed herein is not limited to dedicated entities as described in some embodiments. Rather, the herein disclosed subject matter may be implemented in various ways in various locations in the communication network while still providing the desired functionality.

According to embodiments of the invention, any suitable entity (e.g. components, units and devices) disclosed herein, e.g. the determination unit, are at least in part provided in the form of respective computer programs which enable a processor device to provide the functionality of the respective entities as disclosed herein. According to other embodiments, any suitable entity disclosed herein may be provided in hardware. According to other—hybrid—embodiments, some entities may be provided in software while other entities are provided in hardware.

It should be noted that any entity disclosed herein (e.g. components, units and devices) are not limited to a dedicated entity as described in some embodiments. Rather, the herein disclosed subject matter may be implemented in various ways and with various granularities on device level while still providing the desired functionality. Further, it should be noted that according to embodiments a separate entity (e.g. a software module, a hardware module or a hybrid module) may be provided for each of the functions disclosed herein. According to other embodiments, an entity (e.g. a software module, a hardware module or a hybrid module (combined software/hardware module)) is configured for providing two or more functions as disclosed herein.

It should be noted that the term “comprising” does not exclude other elements or steps. It may also be possible in further refinements of the invention to combine features from different embodiments described herein above. It should also be noted that reference signs in the claims should not be construed as limiting the scope of the claims.

### LIST OF REFERENCE SIGNS

100 Cellular network system
101 Base station
102 User equipment
103 First cell
104 Second cell
200 Cellular network system
210 Local gateway
211 Remote radio head
212 Connection to cellular operator
213 Connection to control unit
300 Cellular network system
400 Cellular network system
410 Transceiver of first base station
412 Determination unit of first base station
414 Control unit of first base station
420 Transceiver of user equipment
440 Transceiver of second base station
442 Control unit of second base station

1. A method for temporarily serving a user equipment by a second cell within a cellular network system, wherein the user equipment is initially served by a first cell, the first cell being assigned to a first base station, wherein the cellular network system comprises the first cell and the second cell being assigned to a second base station, the method comprising
receiving, by the first base station, a request for a service from the user equipment,
determining a needed capacity for the requested service,
determining a need to use capacity being provided by the second base station based on the needed capacity for the requested service,
handing over the user equipment from the first base station of the first cell to the second base station of the second cell, and
handing over the user equipment back from the second base station of the second cell to the first base station of the first cell in response to an end of the need to use capacity being provided by the second base station.

2. The method as set forth in claim 1, wherein determining a needed capacity for the requested service comprises
estimating, by the first base station, quality of service requirements for the requested service.

3. The method as set forth in claim 1, the method further comprises, after determining a need to use capacity being provided by the second base station based on the needed capacity for the requested service, scheduling, by the first base station, a handover based on the needed capacity.

4. The method as set forth in claim 1, wherein the first cell provides a larger coverage than the second cell.

5. The method as set forth in claim 1, wherein the first base station is operated by a first operator and the second base station is operated by a second operator.

6. The method as set forth in claim 1, wherein the first base station corresponds to a first type of base station and the second base station corresponds to a second type of base station.

7. The method as set forth in claim 3, wherein scheduling a handover comprises performing radio resource measurements for detecting the second cell.

8. The method as set forth in claim 7, wherein scheduling a handover comprises
exchanging information between the first base station and the second base station for preparing the handover.

9. The method as set forth in claim 8, wherein exchanging information comprises exchanging information via a direct communication and/or via an indirect communication.

10. The method as set forth in claim 8, further comprising handing over the user equipment (102) back from the second base station of the second cell to the first base station of the first cell in response to a trigger event.

11. The method as set forth in claim 10, wherein the trigger event corresponds to a detection that the quality of the connection via the second base station of the second cell decreases.

12. The method as set forth in claim 1, wherein the first base station monitors the quality of the connection of the user equipment to the second base station of the second cell based on information received from the second base station.

13. The method as set forth in claim 1, wherein the quality of service requirements comprises at least one of data rate, channel quality, and delay.

14. A first base station for temporarily serving a user equipment by a second cell within a cellular network system, wherein the user equipment is initially served by a first cell being assigned to the first base station, wherein the cellular network system comprises the first cell and the second cell being assigned to a second base station, the first base station comprising
a receiving unit being adapted to receive a request for a service from the user equipment,
a determination unit being adapted to determine a needed capacity for the requested service and being adapted to determine a need to use capacity being provided by the second base station based on the needed capacity for the requested service, and
a control unit being adapted to hand over the user equipment from the first base station of the first cell to the second base station of the second cell, and being adapted to hand over the user equipment back from the second base station of the second cell to the first base station of the first cell in response to an end of the need to use capacity being provided by the second base station.

15. A cellular network system, the cellular network system comprising a first base station as set forth in claim 14.
